(19) United States
(12) Patent Application Publication
(10) Pub. No.: US 2024/0039129 A1
(43) Pub. Date: Feb. 1, 2024

(54) ELECTROCHEMICAL CELL AND METHOD FOR PRODUCING AN ELECTROCHEMICAL CELL

(71) Applicant: ElringKlinger AG, Dettingen (DE)

(72) Inventors: Mathias WIDMAIER, Neuhausen auf den Fildern (DE); Christian BECK, Jettingen-Scheppach (DE); Alfonso PEREZ DE LA FUENTE, Esslingen (DE); Fabian HEILAND, Ulm (DE)

(73) Assignee: ElringKlinger AG, Dettingen (DE)

(21) Appl. No.: 18/483,022

(22) Filed: Oct. 9, 2023

Related U.S. Application Data
(63) Continuation of application No. PCT/EP2022/059875, filed on Apr. 13, 2022.

(30) Foreign Application Priority Data
Apr. 21, 2021 (DE) 10 2021 203 995.2

(51) Int. Cl. H01M 50/536; H01M 50/55; H01M 50/15

(52) U.S. Cl. CPC H01M 50/536; H01M 50/55; H01M 50/15

(57) ABSTRACT

The aim of the invention is to provide an electrochemical cell which is as simply constructed as possible and which requires as little production effort as possible. This is achieved by an electrochemical cell, in which a first connection conductor is secured to a cover element in a first connection region by means of a first potting element, said first potting element being surrounded and/or accommodated by a first compensation element of the electrochemical cell in the first connection region, and/or in which a second connection conductor is secured to the cover element in a second connection region by means of a second potting element, said second potting element being surrounded and/or accommodated by a second compensation element of the electrochemical cell in the second connection region.

### RELATED APPLICATION

This application is a continuation of international application No. PCT/EP2022/059875 filed on Apr. 13, 2022, and claims the benefit of German application No. 10 2021 203 995.2 filed on Apr. 21, 2021, which are incorporated herein by reference in their entirety and for all purposes.

### FIELD OF DISCLOSURE

The present invention relates to an electrochemical cell for an electrochemical system.

The present invention further relates to a method for producing an electrochemical cell.

### BACKGROUND

Electrochemical cells are known from DE 10 2020 200 063.8, from DE 10 2017 200 390 A1, from EP 2 541 650 A1 and from US 2015/0214516 A1.

### SUMMARY OF THE INVENTION

The present invention is based on the object of providing an electrochemical cell which is as simple as possible in design and requires the least possible production effort.

This object is achieved according to the invention by an electrochemical cell according to Claim 1.

The electrochemical cell according to the invention is particularly suitable for an electrochemical system, for example for a battery module.

For example, the electrochemical system comprises a plurality of electrochemical cells, preferably a plurality of electrochemical cells according to the invention.

The electrochemical cell is preferably a battery cell, in particular a lithium-ion battery cell, and/or an accumulator cell.

The electrochemical cell preferably comprises an electrochemical element for receiving, storing and/or providing electrical energy.

The electrochemical cell preferably comprises a housing for accommodating the electrochemical element, wherein the housing surrounds an interior space of the electrochemical cell and comprises a cover element.

It can be advantageous if the electrochemical cell comprises a first cell terminal and a second cell terminal for connecting the electrochemical cell to a cell contacting system.

Preferably, the first cell terminal is a positive cell terminal, for example a cathode terminal.

The second cell terminal is preferably a negative cell terminal, for example an anode terminal.

Alternatively, it can be provided that the first cell terminal forms a negative cell terminal and/or that the second cell terminal forms a positive cell terminal.

It may be advantageous for the electrochemical cell to comprise a first connection conductor which connects the electrochemical element to the first cell terminal, and a second connection conductor which connects the electrochemical element to the second cell terminal.

The first connection conductor is preferably fastened to the cover element in a first connection region of the electrochemical cell by means of a first potting element. In particular, the first potting element is surrounded and/or accommodated in the first connection region by a first compensation element of the electrochemical cell.

Additionally or alternatively, the second connection conductor is preferably fastened to the cover element in a second connection region of the electrochemical cell by means of a second potting element. In particular, the second potting element is surrounded and/or accommodated in the second connection region by a second compensation element of the electrochemical cell.

It may be advantageous for the first potting element to be formed from a third polymer material which comprises or to be formed from a first resin material.

Additionally or alternatively, it can be advantageous for the second potting element to be formed from a fourth polymer material which comprises or is formed from a second resin material.

Preferably, the first resin material and/or the second resin material comprise one or more of the following materials or are formed therefrom: epoxy resin material, phenolic resin material, aminoplast material, polyurethane material, silicone material, polyester resin material, ABS (acrylonitrile butadiene styrene) resin material.

The first compensation element is preferably a first tolerance-compensation element, preferably for compensating manufacturing-related tolerances of a material from which the first potting element is formed. The first compensation element preferably serves to compensate for the effects of a volume variation on the functionality of the assembly, in particular on the electrical insulation between a terminal and a cover plate.

The second compensation element is preferably a second tolerance-compensation element, preferably for compensating manufacturing-related tolerances of a material from which the second potting element is formed. The second compensation element preferably serves to compensate for the effects of a volume variation on the functionality of the assembly, in particular on the electrical insulation between a terminal and a cover plate.

The functional effects of volume fluctuations in the region of ±5% of a volume of the first potting element and/or of the second potting element can preferably be compensated by the first compensation element and/or the second compensation element.

Volume fluctuations of the first potting element and/or of the second potting element result in particular from fluctuations of a volume of the first resin material and/or of the second resin material.

Additionally or alternatively, it can be provided that the first compensation element forms a first spacer element and/or that the second compensation element forms a second spacer element. The first spacer element preferably serves as a spacer between the cover element and the first cell terminal. The second spacer element preferably serves as a spacer between the cover element and the second cell terminal.

It can be advantageous if the first compensation element and/or the second compensation element serve to electrically insulate the cover element and/or the first cell terminal and/or the second cell terminal.

It can be favorable if the first compensation element is an insert part. In particular, the first compensation element is produced separately and/or can be handled separately.

The second compensation element is preferably an insert part. In particular, the second compensation element is produced separately and/or can be handled separately.

It can be advantageous if the first compensation element has at least one first depression in which the first potting element is accommodated in part or completely. The at least one first depression is, for example, pocket-shaped.

Additionally or alternatively, it can be advantageous if the second compensation element has at least one second depression in which the second potting element is accommodated in part or completely. The at least one second depression is, for example, pocket-shaped.

It may be favorable if the at least one first depression is formed on a side facing the cover element. Alternatively or additionally, it can be provided for the at least one first depression to be arranged on a side facing away from the cover element.

Preferably, the at least one second depression is arranged on a side facing away from the cover element. Alternatively or additionally, it can be provided for the at least one second depression to be arranged on a side facing the cover element.

For example, the first compensation element has two, for example pocket-shaped, first depressions. The two first depressions are arranged, for example, on both sides of a first compensation section, in a cross-section taken perpendicularly to a main extension plane of the cover element.

In addition, further first depressions and/or further second depressions can be provided.

By arranging first depressions on both sides, a contact surface between the first compensation element and the first potting element can be maximized. In particular, an adhesive bonding of the first cell terminal and of the cover element can be formed by the arrangement of the first depressions on both sides.

The second compensation element preferably has two, for example pocket-shaped, second depressions. The two second depressions are arranged, for example, on both sides of a second compensation section, in a cross-section taken perpendicularly to a main extension plane of the cover element.

By arranging second depressions on both sides, a contact surface between the second compensation element and the second potting element can be maximized. In particular, an adhesive bonding of the second cell terminal and of the cover element can be formed by the arrangement of the second depressions on both sides.

It can be advantageous if the first compensation element has a first edge region which surrounds the first potting element. The first edge region is preferably formed peripherally. For example, the first edge region surrounds the first potting element radially with respect to a central axis of the first connection region.

It may be advantageous for the first compensation element to have a first compensation section which extends from the first edge region towards the first connection conductor. For example, the first compensation section extends radially inwards away from the first edge region and/or into a volume surrounded by the first edge region.

Preferably, the first edge region and the first compensation section form at least one first depression.

It may be advantageous for the second compensation element to have a second edge region which surrounds the second potting element. In particular, the second edge region is formed peripherally around the potting element. For example, the second edge region surrounds the second potting element radially with respect to a central axis of the second connection region.

It can be advantageous for the second compensation element to have a second compensation section which extends from the second edge region towards the second connection conductor. The second compensation section preferably projects radially inwards from the second edge region and/or into a volume surrounded by the second edge region.

The second edge region and the second compensation section preferably form at least one second depression.

In particular for increasing the stability of the first compensation element, it can be provided that the first compensation element has depressions on both sides of the first compensation section for accommodating the first resin material.

It can be provided that the first compensation section has one or more further recessed regions. The one or more further recessed regions are preferably arranged on a side facing the cover element and/or a side of the first compensation element facing away from the cover element.

Additionally or alternatively, it can be provided for the second compensation section to have one or more further recessed regions. The one or more further recessed regions are preferably arranged on a side facing the cover element and/or a side of the second compensation element facing away from the cover element.

In particular for increasing the stability of the second compensation element, it can be provided that the second compensation element has depressions on both sides of the second compensation section for accommodating the second resin material.

Preferably, the first edge region of the first compensation element has one or more first degassing openings, the first edge region preferably having a reduced thickness in the region of the one or more first degassing openings.

The thickness of the first edge region in the region of the one or more first degassing openings preferably corresponds to an average thickness of the first compensation section.

A fluidic connection from the first connection region to a surroundings of the electrochemical cell is preferably formed by the one or more first degassing openings.

It may be favorable if the second edge region of the second compensation element has one or more second degassing openings, the second edge region preferably having a reduced thickness in the region of the one or more second degassing openings.

The thickness of the second edge region in the region of the one or more second degassing openings preferably corresponds to an average thickness of the second compensation section.

A fluidic connection from the second connection region to the surroundings of the electrochemical cell is preferably formed by the one or more second degassing openings.

For example, air can escape into the respective connection region through the one or more first degassing openings and/or through the one or more second degassing openings, during a filling process of a potting material.

It can be advantageous if an average thickness of the first edge region that is taken perpendicularly to the main extension plane of the cover element is approximately 20% or more, in particular approximately 50% or more, greater than an average thickness of the first compensation section taken perpendicularly to the main extension plane of the cover element.

The average thickness is preferably an average material thickness of the respective element.

Additionally or alternatively, it can be provided that an average thickness of the second edge region that is taken perpendicularly to a main extension plane of the cover element is approximately 20% or more, in particular approximately 50% or more, greater than an average thickness of the second compensation section taken perpendicularly to the main extension plane of the cover element.

It can be advantageous if the first compensation section extends, in a cross-section which is taken in parallel with a main extension plane of the cover element, over approximately 25% or more, in particular over approximately 30% or more, of a region of the first connection region surrounded by the first edge region.

It may be advantageous for the second compensation section to extend, in a cross-section which is taken in parallel with the main extension plane of the cover element, over approximately 25% or more, in particular over approximately 30% or more, of a region of the second connection region surrounded by the second edge region.

The first compensation element preferably comprises or is formed from a first polymer material.

The second compensation element preferably comprises or is formed from a second polymer material.

The first polymer material is preferably a thermoplastic polymer material, a thermosetting polymer material, an elastomer polymer material, or a mixture of said materials.

A thermoplastic polymer material, a thermosetting polymer material, an elastomer polymer material or mixtures of said materials is preferably suitable as the second polymer material.

According to a preferred embodiment, the first compensation element and/or the second compensation element comprise or are substantially formed from a thermoplastic polymer material.

In a preferred embodiment of the invention, the first polymer material comprises a polypropylene material, a polybutylene terephthalate material and/or an epoxy resin material.

Additionally or alternatively, the second polymer material preferably comprises a polypropylene material, a polybutylene terephthalate material and/or an epoxy resin material.

It can be provided that the first polymer material comprises one or more electrically conductive fillers.

Additionally or alternatively, the second polymer material preferably comprises one or more electrically conductive fillers.

The one or more electrically conductive fillers are preferably selected from one or more of the following materials:
a₁) one or more carbon-based materials, in particular conductive carbon black, graphite, graphene, carbon nanotubes, carbon fibers and/or carbon nano onions;
a₂) one or more metal powders, in particular aluminum, copper, titanium, iron and/or silver and/or alloys thereof;
a₅) one or more electrically conductive ceramic materials, in particular nitrides or carbides and/or mixtures thereof; and
a₄) one or more electrically conductive polymer materials, in particular poly(3,4-ethylenedioxythiophene) (PEDOT), poly(styrene sulfonate) (PSS), doped polyacetylene, doped polypyrrole, doped polyaniline, doped poly(p-phenylene), doped polythiophene and/or mixtures thereof.

Preferably, the first polymer material and the second polymer material are polymer materials that differ from one another. Alternatively, it can be provided that the first and the second polymer materials are identical polymer materials.

According to a preferred embodiment, the first polymer material, which preferably connects the positive cell terminal to the cover element, comprises one or more electrically conductive fillers.

“Electrically conductive” preferably means that materials described hereby have a conductivity, at 25° C., of approximately 10⁻⁸ S/m or more.

Preferably, the first compensation element forms a resistance element.

In particular, the first compensation element forms an ohmic resistance between the first cell terminal and the housing, which is preferably at least 1·10¹ Ω and/or is preferably at most 1·10⁷ Ω. A maximum current flow can thus be limited, for example in the case of a short-circuit and/or due to metal contaminants.

The material of the first compensation element preferably has a specific electrical conductivity, which is preferably at least 10⁻³ S/m, particularly preferably more than 10⁻² S/m, and/or is preferably at most 10¹ S/m, particularly preferably less than 10¹ S/m. For example, the specific conductivity of the material of the first compensation element is approximately 5 S/m, in particular with a deviation of at most 50%, preferably at most 20%.

By forming the first compensation element as a resistance element, corrosion of the housing can be reduced or avoided.

By using one or more electrically conductive fillers in the first polymer material, the use of one or more electrically conductive fillers in the third polymer material is preferably dispensable.

It can be advantageous if the second polymer material comprises one or more electrically insulating fillers.

Additionally or alternatively, it can be provided that the first polymer material comprises one or more electrically insulating fillers.

According to a preferred embodiment, the second polymer material, which preferably connects the negative cell terminal to the cover element, comprises one or more electrically insulating fillers.

The one or more electrically insulating fillers are preferably selected from one or more of the following materials: silicon dioxide, metal oxides, in particular transition metal oxides, for example titanium dioxide, chalk, one or more silicates, metal nitrides.

“Electrically insulating” preferably means that the materials or elements described hereby have an electrical conductivity of less than approximately 10⁻⁸ S/m at 25° C.

By using one or more electrically insulating fillers in the first polymer material and/or in the first polymer material, a volume shrinkage of the respective polymer material, for example after an injection-molding process, can preferably be reduced.

In particular, polymer material can be saved by using one or more electrically insulating fillers.

It can be advantageous if the first compensation section is a reworked region, for example a region produced by subsequent embossing.

Additionally or alternatively, it can be provided for the second compensation section to be a reworked region, for example a region produced by subsequent embossing.

It may be fadvantageous for the first edge region of the first compensation element to comprise or be formed from a thixotropic material.

Preferably, the second edge region of the second compensation element comprises or is formed from a thixotropic material.

It may be advantageous for the first compensation element, for example the first compensation section, to comprise or be formed by a coating on the cover element and/or a coating on the first cell terminal of the electrochemical cell.

The coating(s) of the first compensation element is or are preferably first coating(s).

It can be advantageous for the second compensation element, for example the second compensation section, to comprise or be formed by a coating on the cover element and/or a coating on the second cell terminal of the electrochemical cell.

The coating(s) of the second compensation element is or are preferably second coating(s).

Preferably, the first compensation element comprises or is formed from a film, for example a self-adhesive film. In particular, the first compensation section is formed by an adhesive film.

It can be provided that the second compensation element comprises or is formed from a film, for example a self-adhesive film. In particular, the second compensation section is formed by an adhesive film.

It can be provided that the first compensation element and/or the second compensation element comprise or are formed by an adhesion promoter element.

The adhesion promoter element preferably comprises or is formed from an adhesion promoter material.

It can be advantageous for the electrochemical cell to comprise an insulating element which in particular serves to insulate the interior space and/or serves for more stable fastening of the first connection conductor and the second connection conductor.

The insulating element is preferably at least approximately plate-shaped and/or fastened on the cover element on an inner side of the cover element facing the interior space, in particular in an integrally bonded and/or force-fitting and/or form-fitting manner.

The insulating element preferably comprises a fifth polymer material or is formed from the fifth polymer material.

The fifth polymer material is preferably a thermoplastic polymer material, for example an injection-moldable and/or electrolyte-resistant thermoplastic polymer material.

Preferably, the insulating element is an injection-molding element.

It can be provided that the insulating element is produced separately, for example in an injection-molding process, and is subsequently connected to the cover element.

Alternatively, it can be provided that the insulating element is injection-molded onto the cover element.

For example, it is conceivable for the insulating element to be formed in two parts and to have two identically formed insulating element parts.

A first insulating element part preferably serves for insulation and/or shielding of a side of the cover element facing the first connection conductor.

A second insulating element part preferably serves for insulation and/or shielding of a side of the cover element facing the second connection conductor.

The insulating element parts preferably each have a resin-material filling opening on a side facing a narrow side of the electrochemical cell.

The resin-material filling openings preferably serve for filling the first resin material into the first connection region and/or for filling the second resin material into the second connection region.

It can be provided that the insulating element parts each have an electrolyte opening.

The electrolyte openings preferably serve for filling and/or emptying the interior space with electrolytes.

Preferably, the insulating element has recesses in the region of a predetermined breaking point in the cover element, in particular regularly arranged recesses.

The recesses are preferably circular.

It can be advantageous if the insulating element has a depression around the connection region in each case, in the region of which depression the insulating element has a reduced thickness. The depressions preferably serve to accommodate resin material and/or delimit a volume formed by the respective connection region with respect to the interior space of the electrochemical cell.

The present invention further relates to a method for producing an electrochemical cell, for example for producing an electrochemical cell according to the invention.

The method comprises providing a cover element which comprises a first opening and/or a second opening.

Preferably, the method comprises positioning a first connection conductor, which is connected or connectable in particular to a first cell terminal, in the first opening.

In particular, a compensation element is produced and/or positioned in a first connection region between the first opening and the first connection conductor and/or the first cell terminal, and a first resin material is filled into the first connection region in a casting process.

In particular after filling the first resin material into the first connection region, the first resin material is preferably dried and/or cured to form a first potting element.

Preferably, a second connection conductor, which is connected or connectable in particular to a second cell terminal, is positioned in the second opening of the cover element.

Preferably, a second compensation element is produced and/or positioned in a second connection region between the second opening and the second connection conductor and/or the second cell terminal, and a second resin material is filled into the second connection region in a casting process.

In particular after filling the second resin material into the second connection region, the second resin material is dried and/or cured to form a second potting element.

One or more features and/or one or more advantages of the electrochemical cell according to the invention preferably apply equally to the method according to the invention.

Preferably, the first resin material is cast and/or filled into the first connection region via a first resin-material filling opening arranged in the cover element.

In particular, a volume formed by the region between an insulating element and the cover element and including a region surrounding the first connection conductor is first filled with the first resin material. In particular, the first resin material ultimately runs into a cavity formed between the first compensation element and the first cell terminal.

The second resin material is preferably cast and/or filled into the second connection region via a second resin material filling opening arranged in the cover element.

In particular, a volume formed by the region between an insulating element and the cover element and including a region surrounding the second connection conductor is first filled with the second resin material. In particular, the second resin material ultimately runs into a cavity formed between the second compensation element and the second cell terminal.

Due to the first compensation element and/or the second compensation element, it is possible to prevent in particular voltage breakdowns via air due to an incomplete filling of the respective connection region by the first resin material and/or the second resin material.

Additionally or alternatively, contamination due to the first resin material and/or the second resin material running out beyond the respective connection region can be prevented by the first compensation element and/or the second compensation element. In particular, contamination on the cover element can lead to complications in a fastening method for fastening the cover element on a further housing component, for example a welding method.

During filling of the first resin material and/or filling of the second resin material into the respective connection region, a viscosity of the first resin material and/or of the second resin material is preferably 10¹ mPa·s or more and/or 10⁵ mPa·s or less.

It may be advantageous for the first compensation element to be applied to the cover element in a printing process, for example by a screen-printing device or a dispenser device. In particular, an increase in height of a first edge region or an embossing of the first compensation section of the second compensation element is then effected.

It can be advantageous for the second compensation element to be applied to the cover element in a printing process, for example by a screen-printing device or a dispenser device, and if an increase in height of a second edge region or an embossing of a second compensation section of the second compensation element is subsequently effected.

It can be provided for the first compensation element and/or the second compensation element to be produced completely or in part in a 3D printing method.

For example, one or more of the following elements are printed on the cover element and/or the first cell terminal and/or the second cell terminal in a 3D printing method:
the first edge region of the first compensation element; and/or
the second edge region of the second compensation element; and/or
the first compensation section of the first compensation element; and/or
the second compensation section of the second compensation element.

Preferably the first resin material is filled, in a flowable state, into the first connection region from a side of the cover element which faces an interior space of the electrochemical cell in a mounted state of the electrochemical cell.

It can be advantageous for the second resin material to be filled, in a flowable state, into the second connection region from a side of the cover element which faces an interior space of the electrochemical cell in a mounted state of the electrochemical cell.

For example, it is conceivable for the first compensation element and/or the second compensation element to be applied to, for example printed on, completely or in part, the cover element.

Preferably, the first compensation element and/or the second compensation element are applied to the cover element by printing, for example in a screen-printing process or in a metering process.

In particular, a flowable mass is printed on and/or applied to the cover element, which is cured subsequently and/or in the process.

In a metering process, the first polymer material and/or the second polymer material are preferably applied to the cover element in the form of a pasty mass, by means of a positive displacement pump or an extruder, on a side facing away from the interior space of the electrochemical cell in the mounted state.

It can be provided that the first edge region and/or the second edge region are formed by a sealing bead.

For example, the first edge region and the first compensation section are applied simultaneously in one method step, for example in a single dispensing step.

Additionally or alternatively, the second edge region and the second compensation section are preferably applied simultaneously in one method step, for example in a single dispensing step.

According to a further embodiment, the first polymer material and/or the second polymer material are applied to, for example printed on, the cover element in such a way that a body is formed which has a homogeneous height (a level). Subsequently, for example, pre-curing of the first polymer material and/or of the second polymer material can be carried out.

After the pre-curing, a central region of the body is preferably embossed, so that the first edge region and the first compensation section, and/or the second edge region and the second compensation section, are formed.

Additionally or alternatively to a subsequent embossing, it can be provided for a region forming the first edge region and/or a region forming the second edge region to be subsequently increased in height. The subsequent increase in height can take place before or after curing of the material applied.

According to a further embodiment, firstly the first edge region and/or the second edge region are applied to the cover element, for example printed thereon. Before or after a curing of the first edge region and/or the second edge region, the first compensation section and/or the second compensation section are preferably applied to the cover element, for example printed thereon. The application is preferably carried out by a dispensing method.

Alternatively, it can be provided that firstly the first compensation section and/or the second compensation section are applied to the cover element, for example by printing. Subsequently, before or after curing of the first compensation section, the first edge region is applied, for example by printing. In particular before or after curing of the second compensation section, the second edge region is applied, for example by printing.

According to a further embodiment, it can be provided that firstly the first edge region and/or the second edge region are applied to the cover element, for example by printing. It may be advantageous for a material which comprises or is formed from a thixotropic material to be used as the material for the first edge region and/or the second edge region.

“Thixotropic” refers to the property of a non-Newtonian fluid to reduce viscosity at a constant shear rate over time. After exposure to shear stress, the initial viscosity is built up again. In simplified terms, this means that a thixotropic liquid becomes thinner the longer it is stirred.

After the application of the first edge region and/or the second edge region, the first polymer material and/or the second polymer material is preferably introduced into a region surrounded by the first edge region and/or by the second edge region.

A volume of the first polymer material and/or of the second polymer material is preferably selected in such a way that contact with the first edge region and/or the second edge region is established in the case of liquefaction and/or running. The first polymer material and/or the second polymer material are preferably selected such that the first polymer material and/or the second polymer material is flowable at least under curing conditions for the respective edge region. The liquefaction and/or the running of the respective material can thus take place during the curing of the respective edge region.

The first polymer material preferably forms the first compensation section. In particular, the second polymer material forms the second compensation section.

It may be advantageous for the first polymer material and/or the second polymer material to comprise a binding material which corresponds to a binding material in the material of the first edge region and/or the second edge region. A capillary effect which prevents the first polymer material and/or the second polymer material from running can thus be minimized.

It can be provided that the first compensation section and/or the second compensation section are formed by a coating at and/or on the cover element. The first edge region and/or the second edge region are subsequently preferably applied to the cover element in a printing process. Alternatively, a prefabricated first edge region and/or a prefabricated second edge region can also be used, for example in the form of insert parts.

According to a further embodiment, it can be provided that the first compensation section is formed by a coating at and/or on the first cell terminal. In embodiments in which the first cell terminal forms the cathode, it may be advantageous for the coating to comprise one or more electrically conductive fillers. Additionally or alternatively, the second compensation section can be formed by a coating at and/or on the second cell terminal.

The first edge region and/or the second edge region are subsequently preferably applied to the respective cell terminal in a printing process. Alternatively, a prefabricated first edge region and/or a prefabricated second edge region can also be used, for example in the form of insert parts.

In addition or as an alternative to a coating, a film, for example a self-adhesive film, can also be glued onto the first cell terminal, the second cell terminal and/or the cover element. Subsequently, a first edge region and/or a second edge region are preferably produced, for example by printing or by fastening a first insert part and/or a second insert part.

Further preferred features and/or advantages of the invention form the subject-matter of the following description and the drawings illustrating embodiments.

### BRIEF DESCRIPTION OF THE DRAWINGS

FIG. 1 is a schematic plan view of a cover element of a first embodiment of an electrochemical cell, in which a first compensation element is arranged between a first cell terminal and the cover element and in which a second compensation element is arranged between a second cell terminal and the cover element;

FIG. 2 is a schematic side view of a part of the electrochemical cell from FIG. 1;

FIG. 3 is a schematic view from below of a part of the electrochemical cell from FIGS. 1 and 2, wherein a two-part insulating element of the electrochemical cell is to be seen, which forms an insulation of the cover element with respect to an electrolyte;

FIG. 4 is a detail of a schematic sectional illustration along a plane denoted by IV in FIG. 1;

FIG. 5 is a schematic plan view of a compensation element of the electrochemical cell from FIGS. 1 to 4;

FIG. 6 is a schematic plan view of the compensation element from FIG. 5 during a filling process of a resin material which forms a potting element in the cured and/or dried state;

FIG. 7 is a schematic perspective view of a cell terminal and a compensation element of the electrochemical cell from FIGS. 1 to 4;

FIG. 8 is a schematic perspective view of a compensation element of the electrochemical cell from FIGS. 1 to 4, from a side facing away from an interior space of the electrochemical cell;

FIG. 9 is a schematic perspective view of a compensation element of the electrochemical cell from FIGS. 1 to 4, from a side facing an interior space of the electrochemical cell;

FIG. 10 is a schematic perspective view of a cell terminal and a compensation element of a further embodiment of an electrochemical cell, in which the compensation element has no degassing opening;

FIG. 11 is a schematic perspective view of the compensation element from FIG. 10, from a side facing away from the interior space of the electrochemical cell;

FIG. 12 is a schematic perspective view of the compensation element from FIGS. 10 and 11, from a side facing the interior space of the electrochemical cell;

FIG. 13 is a schematic perspective view of a cell terminal and a compensation element of a further embodiment of an electrochemical cell, in which the compensation element has a degassing opening which extends completely through an edge region of the compensation element;

FIG. 14 is a schematic perspective view of the compensation element from FIG. 13, from a side facing away from the interior space of the electrochemical cell;

FIG. 15 is a schematic perspective view of the compensation element from FIGS. 13 and 14, from a side facing away from the interior space of the electrochemical cell;

FIG. 16 is a schematic perspective view of a cell terminal and a compensation element of a further embodiment of an electrochemical cell, in which the compensation element has a depression for accommodating a resin material, in each case on a side facing away from the interior space of the electrochemical cell and on a side facing the interior space;

FIG. 17 is a schematic perspective view of the compensation element from FIG. 16, from a side facing away from the interior space of the electrochemical cell;

FIG. 18 is a schematic perspective view of the compensation element from FIGS. 16 and 17, from a side facing the interior space of the electrochemical cell;

FIG. 19 is a schematic perspective view of a cell terminal and a compensation element of a further embodiment of an electrochemical cell, in which the compensation element has two depressions on a side facing away from the interior space of the electrochemical cell and a single depression on a side facing the interior space;

FIG. 20 is a schematic perspective view of the compensation element from FIG. 19, from a side facing away from the interior space of the electrochemical cell;

FIG. 21 is a schematic perspective view of the compensation element from FIGS. 19 and 20, from a side facing the interior space of the electrochemical cell;

FIG. 22 is a schematic view of an embodiment of a method for producing an electrochemical cell, in which a resin material is applied to the cover element, a compensation section subsequently being embossed into the compensation element;

FIG. 23 is a schematic view of a further embodiment of a method for producing an electrochemical cell, in which a resin material is applied to the cover element, wherein an edge region of the compensation element is achieved by increasing the height of the applied material, before or after curing;

FIG. 24 is a schematic view of a further embodiment of a method for producing an electrochemical cell, in which an edge region of the compensation element is applied separately and, before or after a curing, a compensation section is applied to the cover element, for example printed thereon;

FIG. 25 is a schematic view of a further embodiment of a method for producing an electrochemical cell, in which firstly a resin material is applied to the cover element in a planar manner, for example printed thereon, the resin material forming a compensation section in a cured state, an edge region subsequently being applied around and on the compensation section after curing of the compensation section; and

FIG. 26 is a schematic view of a further embodiment for producing an electrochemical cell, in which contact between the edge region and the compensation section occurs due to liquefaction of a polymer material of which the compensation section is formed.

The same or functionally equivalent elements are provided with the same reference signs in all figures.

### DETAILED DESCRIPTION OF THE DRAWINGS

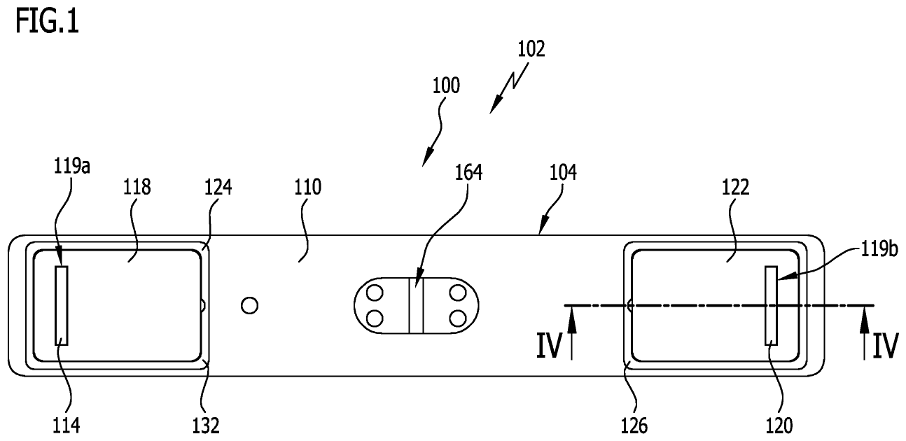

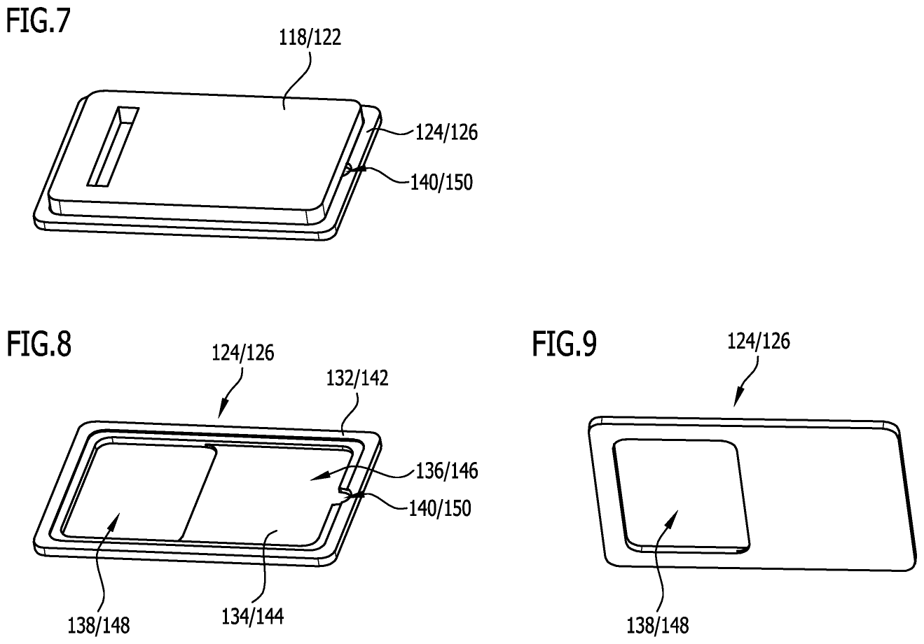

FIGS. 1 to 9 show a first embodiment of an electrochemical cell 100 (not shown in its entirety in the drawings), as well as individual components thereof.

The electrochemical cell 100 is for example a battery cell and/or an accumulator cell.

Preferably, the electrochemical cell 100 is a lithium ion cell.

The electrochemical cell 100 preferably forms a component of an electrochemical system 102 (not shown in its entirety in the drawings), which comprises in particular a plurality of electrochemical cells 100.

The electrochemical system 102 is for example an accumulator module and/or a battery module.

For example, the electrochemical cell 100 is used in a vehicle.

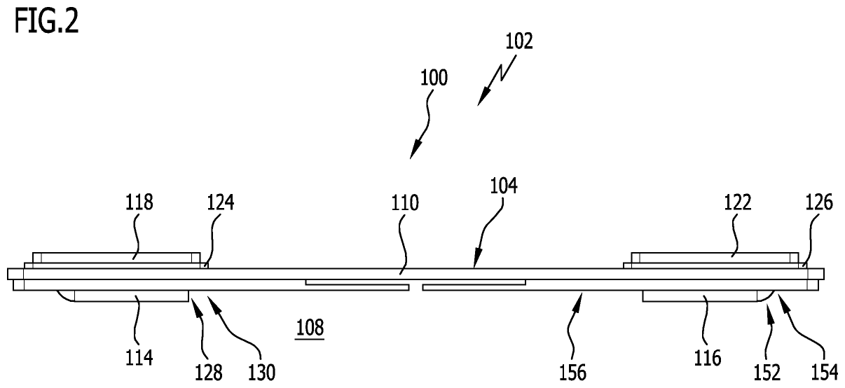

The electrochemical cell 100 preferably comprises a housing 104 for accommodating an electrochemical element (not shown), for example in the form of what is known as a cell winding. The housing 104 surrounds an interior space 108 (indicated in FIG. 2) of the electrochemical cell 100, and in the present case comprises a cover element 110 as a first housing component.

The cover element 110 preferably covers a further housing component (not shown) of the housing 104 and/or is connected in a fluid-tight manner to the further housing component.

The further housing component 112 is, for example, trough-shaped or cup-shaped. It preferably surrounds the interior space 108 of the electrochemical cell 100 on five sides.

Preferably, the housing 104 of the electrochemical cell 100 is at least approximately cuboid.

For example, the electrochemical cell 100 is a prismatic cell.

It can be advantageous if the cover element 110 is plate-shaped, for example made of a sheet metal. In particular, the cover element 110 comprises a metal material, for example aluminum, or is formed from the metal material. For example, the cover element 110 is formed from a metal sheet, for example from an aluminum sheet.

The cover element 110 is preferably integrally bonded to the further housing component of the housing 104, preferably by means of welding, for example by means of laser welding.

It can be advantageous for the electrochemical cell 100 to comprise a first connection conductor 114 and a second connection conductor 116.

The first connection conductor 114 serves in particular for an electrical connection of the electrochemical element to a first cell terminal 118 of the electrochemical cell 100.

The second connection conductor 116 preferably serves for an electrical connection of the electrochemical element to a second cell terminal 122 of the electrochemical cell 100.

The second cell terminal 122 preferably comprises a metal material, for example aluminum, or is formed therefrom.

For example, the first cell terminal 118 is designed as a cathode.

For example, the second cell terminal 122 is designed as an anode.

Alternatively, it can be provided that the first cell terminal 118 is an anode and that the second cell terminal 122 is a cathode (not shown).

It may be advantageous for the first cell terminal 118 likewise to comprise or be formed from the first metal material, for example aluminum.

The electrical connection of the electrochemical element to the first cell terminal 118 and/or to the second cell terminal 122 is achieved in particular by the respective connection conductor 114, 116 being fastened both to the electrochemical element and to the respective cell terminal 118, 122.

In the present case, the first connection conductor 114 and/or the second connection conductor 116 are fastened to the electrochemical element, in particular from above, on a side of the electrochemical element 100 facing the cover element 110.

It can be advantageous for the first cell terminal 118 and the second cell terminal 122 to each have a passage opening 119a, 119b.

The passage openings 119a, 119b are, for example, closed and/or filled by the respective connection conductor 114, 116.

The first connection conductor 114 is preferably formed in one piece and/or is formed continuously from the same material. For example, the first connection conductor 114 comprises or is formed from the first metal material, for example aluminum.

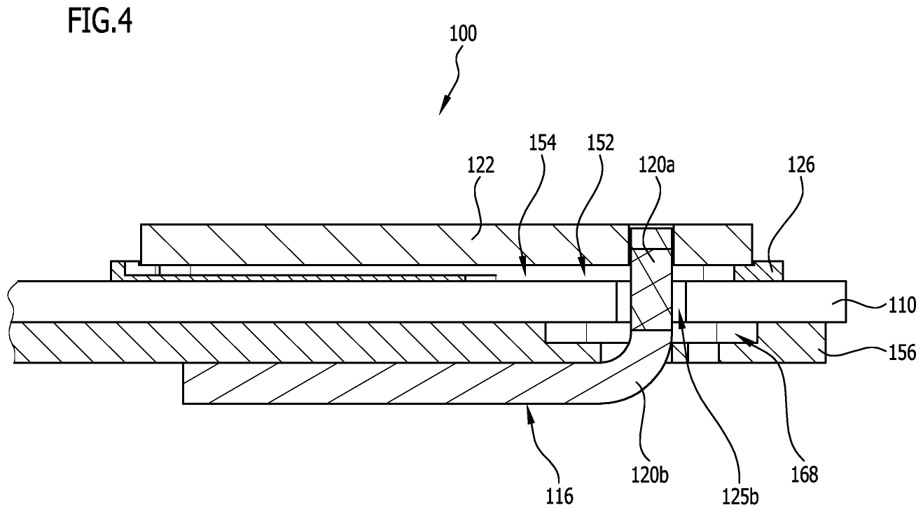

In the present case, the second connection conductor 116 is formed in multiple parts and comprises a plurality of connection conductor components 120a, 120b (cf. FIG. 4).

A first connection conductor component 120a of the second connection conductor 116 is preferably guided through and/or into the passage opening 119b of the second cell terminal 122.

The first cell terminal 118 and the second cell terminal 122 are designed identically in the present case.

The passage openings 119a, 119b of the first cell terminal 118 and of the second cell terminal 122 are in particular of a shape which is at least approximately complementary to a cross-section of the respective connection conductor 114, 116.

For example, the first cell terminal 118 and/or the second cell terminal 122 each have a cuboidal recess.

The second cell terminal 122 is preferably connected to a first connection conductor component 120a of the second connection conductor 122 in an integrally bonded manner, for example by means of welding.

The first connection conductor component 120a preferably comprises the same material as the second cell terminal 122 or is formed therefrom.

It can be advantageous if the first connection conductor component 120a of the first connection conductor 122 comprises aluminum or is formed therefrom.

The second connection conductor 122 preferably comprises a second connection conductor component 120b, which in particular comprises or is formed from a further metal material. The further metal material differs in particular from the first metal material.

For example, the second connection conductor component 120b of the second connection conductor 116 comprises or is formed from copper.

It may be advantageous for the first connection conductor component 120a and the second connection conductor component 120b of the second connection conductor 116 to be connected to one another in an integrally bonded manner, for example by means of laser welding and/or roll plating.

The first connection conductor 114 and/or the second connection conductor 116 preferably are at least approximately L-shaped in a cross-section taken perpendicularly to a main extension plane of the cover element 110.

The cover element 110 preferably comprises a first opening through which the first connection conductor 114 is guided.

The first opening in the cover element 110 is, for example, at least a cathode opening.

Alternatively, it can be provided that the first opening of the cover element 110 is an anode opening (not shown).

It can be advantageous if the first connection conductor 114 and the first cell terminal 118 fastened thereto are fastened in a first connection region 130 by means of a first potting element 128.

For example, a region formed in the region of the first opening between the cover element 110 and the first connection conductor 122 is filled.

The first potting element 128 is preferably formed from a third polymer material which comprises or is formed from a first resin material.

The electrochemical cell 100 preferably comprises a first compensation element 124, in particular a tolerance-compensation element, which serves, for example, to seal the first connection region 130 and/or to compensate manufacturing-related tolerances of a volume of the first potting element 128.

Additionally or alternatively, it can be provided that the first compensation element 124 forms a first spacer element. The first spacer element preferably serves as a spacer between the cover element 110 and the first cell terminal 118.

It can be advantageous if the first compensation element 124 is used for electrical insulation of the cover element 110 and/or the first cell terminal 118.

Preferably, the first compensation element 124 is arranged on a side of the cover element 110 facing away from the interior space 108 of the electrochemical cell 100. For example, the first compensation element 124 rests against the cover element 110 and/or on the cover element 110 on a side of the cover element 110 facing away from the interior space 108.

As can be seen in particular in FIG. 5, the first compensation element 124 preferably has a first edge region 132 which, in the mounted state, in particular forms a lateral boundary of the first potting element 128.

A lateral boundary is in particular understood to mean a boundary along radial directions with respect to a central axis of the first connection region 130.

It may be advantageous for the first edge region 132 to be designed to be peripheral.

A first compensation section 134 of the first compensation element 124 preferably extends in a region surrounded by the first edge region 132.

In the present case, the first compensation section 134 projects into the first connection region 130.

As can be seen in particular in FIGS. 8 and 9, the first compensation element 124 can be formed flat on a side facing the cover element 110, in particular in such a way that it rests against the cover element 110 in a planar manner and/or a planar contact surface is formed. On a side facing away from the cover element 110, the first compensation element 124 preferably has a first depression 136, which is formed, for example, by the first compensation section 134 and the first edge region 132.

The first depression 136 of the first compensation element 124 serves in particular for receiving the first resin material in a flowable state, for example during a filling process.

For example, the first depression 136 forms a pocket for receiving the first resin material and/or for stabilizing the first connection region 130.

It can be advantageous if an average thickness of the first edge region 132 that is taken perpendicularly to the main extension plane of the cover element 110 is approximately 20% or more, in particular approximately 50% or more, greater than an average thickness of the first compensation section 134 taken perpendicularly to the main extension plane of the cover element 110.

The average thickness is preferably an average material thickness of the respective element.

It can be advantageous if the first compensation section 134 extends, in a cross-section taken in parallel with a main extension plane of the cover element 110, over approximately 25% or more, in particular over approximately 30% or more, of a region of the first connection region 130 surrounded by the first edge region 132.

As can be seen in particular in FIGS. 5 and 8, the first depression 136 of the first compensation element 124 is preferably at least approximately rectangular.

Preferably, the first compensation section 134 extends, in a cross-section taken in parallel with the main extension plane of the cover element 110, over approximately 30% or more of a cross-sectional area of the first compensation element 124, in particular approximately 50% or more.

In particular, the first compensation section 134 extends, in a cross-section taken in parallel with the main extension plane of the cover element 110, over approximately 80% or less of a cross-sectional area of the first compensation element 124, for example over approximately 75% or less.

It may be advantageous for a remaining cross-sectional area of the first compensation element 124, which is surrounded by the first edge region 132, to be formed by a first passage opening 138 of the first compensation element 124.

The first connection conductor 114 is preferably guided through the first passage opening 138 of the first compensation element 124 in the mounted state.

It can be provided that the first edge region 132 has a step-shaped drop. The step-shaped drop forms, for example, a transition between a main body of the first edge region 132 and the first compensation section 134.

It may be advantageous for the first compensation element 124 to have one or more (in the present case, one) degassing openings 140, which in particular serve as a fluidic connection between the first depression 136 and surroundings of the first compensation element 124.

The degassing opening 140 is designed, for example, as a recess in the first edge region 132.

With regard to the shape, the first compensation element 124 and the second compensation element 126 are designed identically in the present case. In this respect, the statements regarding the first edge region 132, the first compensation section 134, the first depression 136, the first passage opening 138 and the first degassing opening 140 of the first compensation element 124 apply equally to a second edge region 142, a second compensation section 144, a second depression 146, a second passage opening 148 and a second degassing opening 150 of the second compensation element 126.

In the mounted state of the electrochemical cell 100, the first compensation element 124 and the second compensation element 126 are preferably arranged relative to one another in such a way that the degassing openings 140, 150 face one another and the passage openings 138, 148 are arranged facing away from one another.

During the production of the electrochemical cell 100, the first compensation element 124 is preferably positioned on the cover element 110 and the first resin material is filled into the first connection region 130 in a flowable state so that it surrounds the first connection conductor 114.

Additionally or alternatively, the second compensation element 126 is preferably positioned on the cover element 110 and a second resin material is introduced into a second connection region 152 in a flowable state, so that it surrounds the first connection conductor 114.

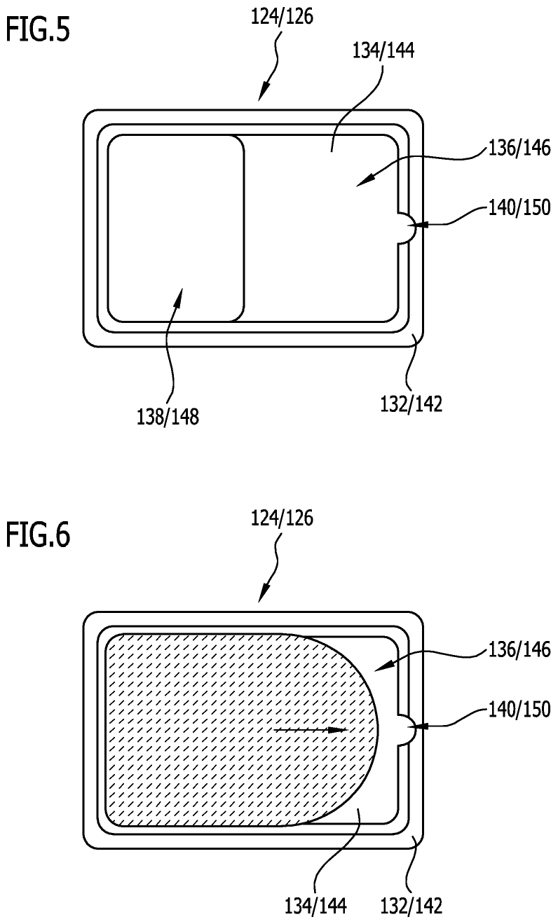

In the flowable state, the first resin material and/or the second resin material in particular form a potting compound. A flow direction of the first resin material and/or second resin material preferably runs from the first passage opening 138 to the first degassing opening 140 or from the second passage opening 148 to the second degassing opening 150. The first resin material/the second resin material are shown hatched in FIG. 6 during a filling process. The flow direction of the respective resin material is indicated by an arrow.

Functional effects of variations in a volume of the respective resin material can be compensated, for example, by the respective compensation element 124, 126. For example, the first compensation section 134 or the second compensation section 144 may be covered only in part by the respective resin material.

Due to the fact that non-insulated regions can be avoided by the first compensation element 124 and/or the second compensation element 126, in particular voltage breakdowns can be minimized and/or prevented.

During the filling process of the first resin material, a region of the first connection region 130 facing the interior space 108 preferably fills first, and next a region between the first cell terminal 118 and the cover element 110.

In particular, during the filling process of the second resin material, a region of the second connection region 152 facing the interior space 108 fills first, and next a region between the second cell terminal 122 and the cover element 110.

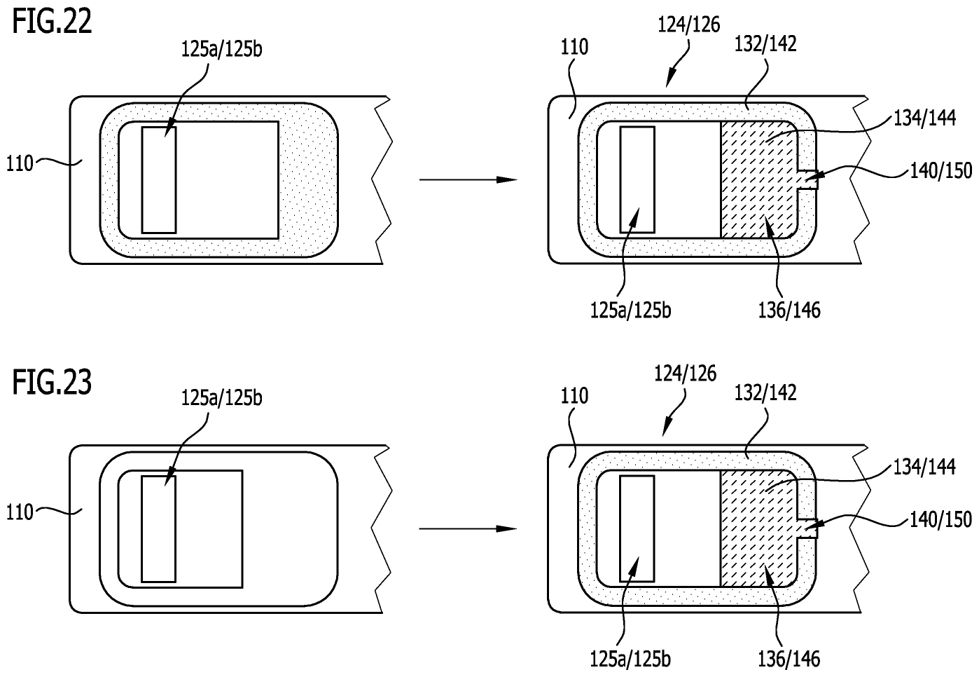

The first compensation element 124 and/or the second compensation element 126 can be produced, for example, according to a method described in connection with FIGS. 22 to 26.

By using the first resin material and/or the second resin material, it is possible, in particular, to prevent or reduce cracking which can occur, for example, during injection-molding of a thermoplastic material. As a result, a sealing effect of the first potting element and/or of the second potting element is preferably optimized.

It can be advantageous if the first potting element and/or the second potting element are filler potting elements.

It may be advantageous for the third polymer material to have a hardness of approximately 40 Shore D or more, in particular of approximately 50 Shore D or more, for example of approximately 60 Shore D or more.

Preferably, the third polymer material has a hardness of approximately 100 Shore D or less, in particular of approximately 97 Shore D or less, for example of approximately 95 Shore D or less.

In particular, the fourth polymer material has a hardness of approximately 40 Shore D or more, in particular of approximately 50 Shore D or more, for example of approximately 60 Shore D or more.

It may be advantageous for the fourth polymer material to have a hardness of approximately 100 Shore D or less, in particular of approximately 97 Shore D or less, for example of approximately 95 Shore D or less.

The hardness is determined in particular according to DIN EN ISO 868.

The mentioned hardnesses preferably also apply to the first resin material and/or the second resin material in a cured state.

It can be advantageous if the third polymer material has a glass transition temperature of approximately 90° C. or more, in particular of approximately 95° C. or more, for example of approximately 100° C. or more.

It may be advantageous for the fourth polymer material to have a glass transition temperature of approximately 90° C. or more, in particular of approximately 95° C. or more, for example of approximately 100° C. or more.

The stated values for the glass transition temperature preferably also apply to the first resin material and/or the second resin material in a cured state.

Preferably, the first resin material and/or the second resin material comprise one or more of the following materials or are formed therefrom: epoxy resin material, phenolic resin material, aminoplast material, polyurethane material, silicone material, polyester resin material, ABS (acrylonitrile butadiene styrene) resin material.

An epoxy resin material, for example an epoxy resin, has proven to be particularly advantageous for use as a first resin material and/or as a second resin material. This has optimized resistance to corrosion. This can be advantageous in particular with regard to contact with an electrolyte used in the interior space of the electrochemical cell.

In particular, epoxy resin materials have optimized gastightness, which is why sealing with epoxy resin materials is advantageous for optimized tightness.

When an epoxy resin material is used as the first resin material and/or the second resin material, small volume shrinkages preferably occur during curing and/or drying. Cracking in the first potting element and/or second potting element can thus be reduced or prevented.

Preferably, one-component resin materials are used as the first resin material and/or second resin material.

It may be advantageous if the third polymer material and/or the fourth polymer material are highly crosslinked materials, for example highly crosslinked epoxy resin materials.

It can be advantageous if the first resin material and/or the second resin material, during the production of the first potting element 128 and/or of the second potting element 154, have a viscosity of approximately 10² mPa·s or more, in particular of approximately 10³ mPa·s or more.

The viscosity of the first resin material and/or of the second resin material during production of the electrochemical cell 100 is preferably approximately 10⁶ mPa·s or less, in particular 10⁵ mPa·s or less.

Filling the first connection region 130 with the first resin material and/or the second connection region 152 with the second resin material preferably takes place at ambient pressure.

In particular, in order to prevent oxygen and/or water diffusion into the interior space 108 of the electrochemical cell 100, it can be advantageous for the first resin material and/or the second resin material to comprise one or more fillers.

The one or more fillers can also minimize diffusion of the electrolyte out of the interior space 108 of the electrochemical cell 100.

The one or more fillers are in particular selected from one or more of the following: inorganic fillers, in particular silicon oxide, carbonate, carbide, in particular silicon carbide, nitride, in particular metal nitride, metal oxide.

It may be advantageous if the compensation element 124 comprises or is made of a first polymer material. For example, it can be provided that the first polymer material comprises a thermoplastic polymer material, a thermosetting polymer material, an elastomer polymer material or mixtures thereof.

In a preferred embodiment of the invention, the first polymer material comprises a polypropylene material, a polybutylene terephthalate material and/or an epoxy resin material.

For example, the first compensation element 124 comprises or is formed from a thermoplastic polymer material.

According to a preferred embodiment, the first compensation element 124 is produced in an injection-molding process.

In particular in embodiments in which the first compensation element is arranged adjacent to the cathode, it may be advantageous for the first polymer material to comprise one or more electrically conductive fillers. For example, one or more of the following fillers are suitable as electrically conductive fillers:
a₁) one or more carbon-based materials, in particular conductive carbon black, graphite, graphene, carbon nanotubes, carbon fibers and/or carbon nano onions;
a₂) one or more metal powders, in particular aluminum, copper, titanium, iron and/or silver and/or alloys thereof;
a₃) one or more electrically conductive ceramic materials, in particular nitrides or carbides and/or mixtures thereof; and
a₄) one or more electrically conductive polymer materials, in particular poly(3,4-ethylenedioxythiophene) (PEDOT), poly(styrene sulfonate) (PSS), doped polyacetylene, doped polypyrrole, doped polyaniline, doped poly(p-phenylene), doped polythiophene and/or mixtures thereof.

Preferably, the first compensation element 124 forms a resistance element. In particular, the first compensation element 124 forms an ohmic resistance between the first cell terminal 114 and the housing 104, which is preferably at least 1·10⁻¹ Ω and/or is preferably at most 1·10⁷ Ω.

The material of the first compensation element 124 preferably has a specific electrical conductivity which is preferably at least 10⁻³ S/m, particularly preferably more than 10⁻² S/m, and/or is preferably at most 10³ S/m, particularly preferably less than 10¹ S/m. For example, the specific conductivity is approximately 5 S/m.

Preferably, the second compensation element 126 comprises or is formed from a second polymer material.

The first polymer material and the second polymer material are preferably different from each other. Alternatively, identical polymer materials can also be used as the first and second polymer material.

For example, it can be provided that the second polymer material comprises a thermoplastic polymer material, a thermosetting polymer material, an elastomer polymer material or mixtures thereof.

In a preferred embodiment of the invention, the second polymer material comprises a polypropylene material, a polybutylene terephthalate material and/or an epoxy resin material.

For example, the second compensation element 126 comprises or is formed from a thermoplastic polymer material.

According to a preferred embodiment, the second compensation element 126 is produced in an injection-molding process.

In particular in embodiments in which the second compensation element 126 is arranged adjacently to the anode, it can be advantageous if the second polymer material comprises one or more electrically insulating fillers.

The one or more electrically insulating fillers are, for example, selected from one or more of the following materials: silicon dioxide, metal oxides, in particular transition metal oxides, for example titanium dioxide, chalk, one or more silicates, metal nitrides.

It can be advantageous if the electrochemical cell 100 comprises an insulating element 156 which, in particular, serves to insulate the interior space 108 and/or serves for more stable fastening of the first connection conductor 114 and the second connection conductor 116.

The insulating element 156 is preferably at least approximately plate-shaped and/or fastened to the cover element 110, on an inner side of the cover element 110 facing the interior space 108, in particular in an integrally bonded and/or force-fitting and/or form-fitting manner.

The insulating element 156 preferably comprises a fifth polymer material or is formed from the fifth polymer material.

The fifth polymer material is preferably a thermoplastic polymer material, for example an injection-moldable and/or electrolyte-resistant thermoplastic polymer material.

Preferably, the insulating element 156 is an injection-molding element.

It can be provided that the insulating element 156 is produced separately, for example in an injection-molding process, and is subsequently connected to the cover element 110.

Alternatively, it can be provided that the insulating element 156 is injection-molded onto the cover element 110.

In the present case, the insulating element 156 is formed in two parts and has two identically formed insulating element parts 156a and 156b.

A first insulating element part 156a preferably serves for insulation and/or shielding of a side of the cover element 110 facing the first connection conductor 114.

A second insulating element part 156b preferably serves for insulation and/or shielding of a side of the cover element 110 facing the second connection conductor 116.

The insulating element parts 156a, 156b preferably each have a resin-material filling opening 160a, 160b on a side facing a narrow side of the electrochemical cell 100.

The resin-material filling openings 160a, 160b preferably serve for filling the first resin material and/or the second resin material into the first connection region 130 or the second connection region 152.

It can be provided that the insulating element parts 156a, 156b each have an electrolyte opening 162a, 162b. The electrolyte openings 162a, 162b are preferably used for filling and/or emptying the interior space 108 with electrolytes.

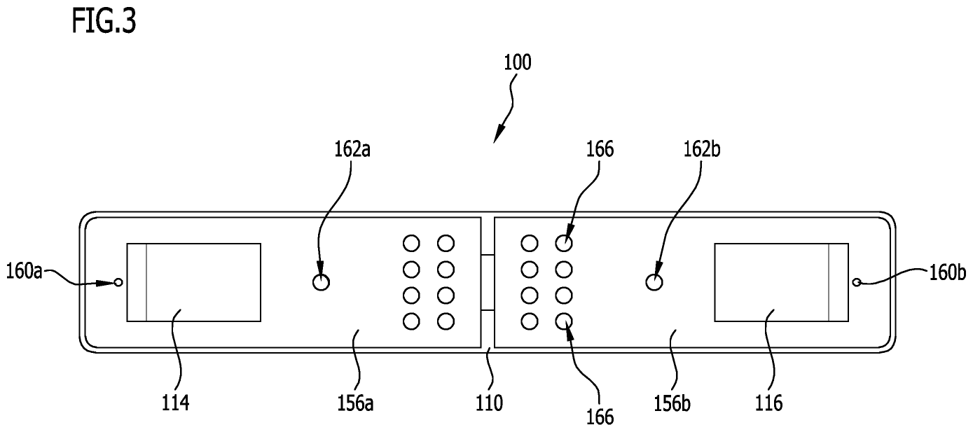

As can be seen in particular in FIG. 3, the insulating element 156 preferably has recesses 166 (denoted by way of example), in particular regularly arranged, in the region of a predetermined breaking point in the cover element 110.

The recesses 166 are preferably circular.

It can be advantageous if the insulating element 156 has a depression 168 in each case around the connection region 130, 152 (cf. FIG. 4), in the region of which the insulating element 156 has a reduced thickness. The recesses 168 preferably serve to receive resin material and/or delimit a volume formed by the respective connection region 130, 152 with respect to the interior space 108 of the electrochemical cell 100.

It can be provided for the first compensation element 124 and/or the second compensation element 126 to comprise a first coating and/or a second coating which is produced on and/or at the cover element 110.

It may be favorable if the coating comprises or is formed from an adhesion promoter material which serves, for example, to provide adhesion between a main body of the first compensation element 124 and/or a main body of the second compensation element 126 and the cover element 110.

It can be advantageous if a material of the first coating, which is arranged on the cathode, has one or more electrically conductive fillers. In particular, the first coating forms a resistance element.

Additionally or alternatively, it can be provided for a first coating to be applied to the first cell terminal 118 and/or a second coating 122 to be applied to the second cell terminal 122, for example to a side facing the cover element 110. The first coating and/or the second coating preferably serve as an adhesion promoter between the first cell terminal 118 and a main body of the first compensation element 124, and/or the second cell terminal 122 and a main body of the second compensation element 126.

It may be fadvantageous for a material of the first coating, which is arranged on the cathode, to comprise one or more electrically conductive fillers. For example, the first coating forms a resistance element.

Additionally or alternatively, it can be provided for the first compensation element 124 and/or the second compensation element 126 to comprise a film, for example an adhesive film, by means of which a main body of the respective compensation element 124, 126 is fastened to the cover element 110 or the respective cell terminal 118, 122.

It may be favorable if the film which is arranged on the anode comprises one or more electrically insulating fillers.

It can be advantageous if the film which is arranged on the cathode comprises one or more electrically conductive fillers.

Preferably, the film, for example the adhesive film, is printed onto the cover element 110 or the respective cell terminal 118, 122.

According to a preferred embodiment, it can be provided for the first compensation element 124 and/or the second compensation element to be applied to the cover element 110 completely or in part in a 3D printing method.

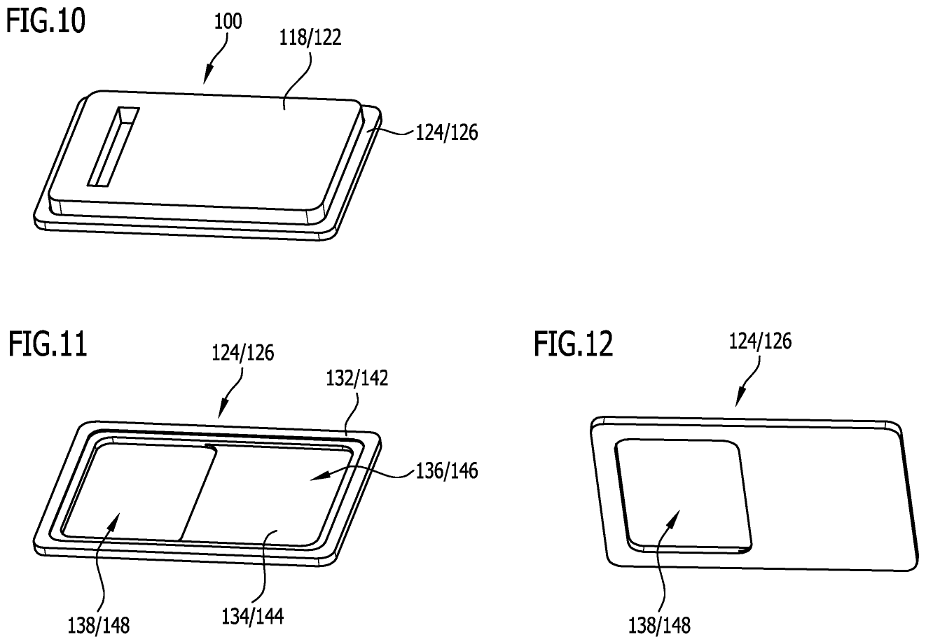

FIGS. 10 to 12 show a cell terminal 118, 122 and a compensation element 124, 126 of a further embodiment of a further embodiment of an electrochemical cell 100 that is not shown in its entirety in the drawings.

The further embodiment of an electrochemical cell 100 that is shown in part in FIGS. 10 to 12 differs in its structure and function from the first embodiment shown in FIGS. 1 to 9 essentially in that the compensation element 124, 126 has no degassing openings 140, 150.

Otherwise, the further embodiment of an electrochemical cell 100 shown in part in FIGS. 10 to 12 corresponds substantially in its structure and function to the first embodiment shown in FIGS. 1 to 9, so that reference is made to the description thereof in this respect.

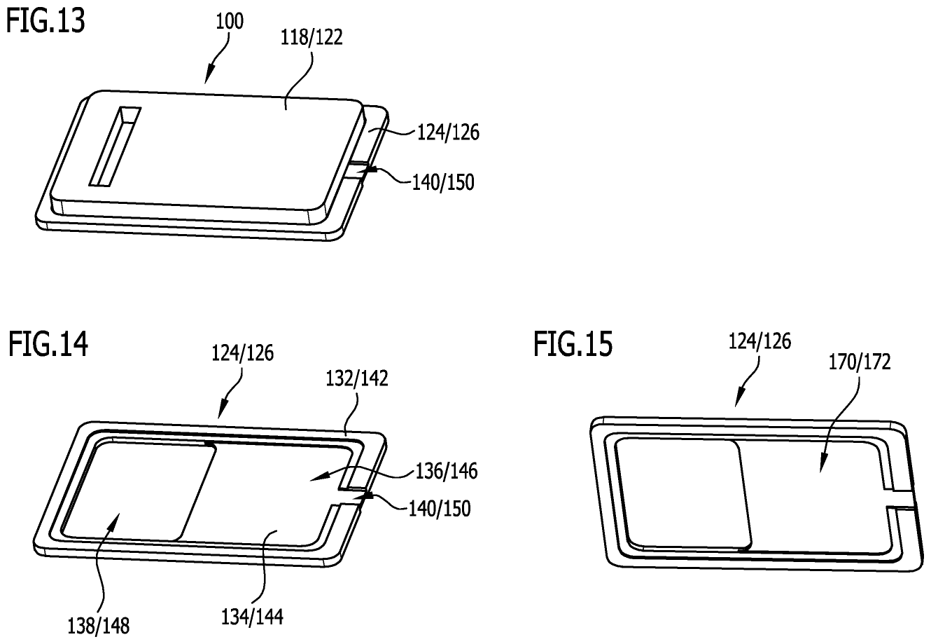

FIGS. 13 to 15 show a cell terminal 118, 122 and a compensation element 124, 126 of a further embodiment of a further embodiment of an electrochemical cell 100 that is not shown in its entirety in the drawings.

The further embodiment of an electrochemical cell 100 shown in part in FIGS. 13 to 15 differs in its structure and function from the first embodiment shown in FIGS. 1 to 9 essentially in that the degassing opening 140, 150 is formed in the manner of a channel.

For example, the first degassing opening 140 extends from the first compensation section right up to an edge of the first compensation element 124.

It can be advantageous for the first compensation element 124 to be designed so as to be mirror-symmetrical. An axis of symmetry preferably extends in parallel with the main extension plane of the cover element 110. In particular, the first compensation element 124 has a further depression 170 on a side facing the cover element 110.

Additionally or alternatively, in particular the second degassing opening 150 extends from the second compensation section 144 right up to an edge of the second compensation element 126.

It may be advantageous if the second compensation element 126 is designed so as to be mirror-symmetrical. An axis of symmetry preferably extends in parallel with the main extension plane of the cover element 110. In particular, the second compensation element 126 has a further depression 172 on a side facing the cover element 110.

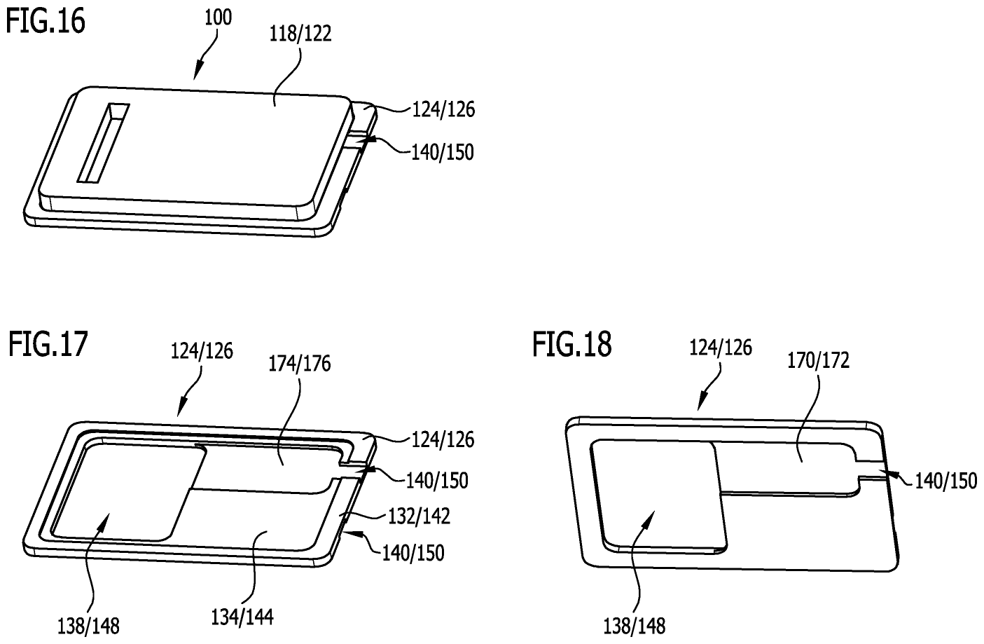

Otherwise, the further embodiment of an electrochemical cell 100 shown in part in FIGS. 13 to 15 corresponds substantially in its structure and function to the embodiment shown in FIGS. 1 to 9, so that reference is made to the description thereof in this regard. FIGS. 16 to 18 show a cell terminal 118, 122 and a compensation element 124, 126 of a further embodiment of a further embodiment of an electrochemical cell 100 that is not shown in its entirety in the drawings.

The further embodiment of an electrochemical cell 100 shown in part in FIGS. 16 to 18 differs in its structure and function from the first embodiment shown in FIGS. 1 to 9 essentially in that the compensation section 134, 144 has a further recessed region 174, 176.

Preferably, the first compensation section 134 of the first compensation element 124 has a first further recessed region 174. In the region of the first further recessed region 174, an average thickness of the first compensation section 134 is preferably at least approximately 10% less, in particular at least approximately 20% less, and/or at most approximately 80% less, in particular approximately 70% less, than an average thickness of the first compensation section 134 in the surrounding regions.

The thickness is preferably defined perpendicularly to the main extension plane of the cover element 110.

A cross-sectional area of the first further recessed region 174 is preferably approximately 20% or more and/or approximately 80% or less than a cross-sectional area of the first compensation section 134 overall.

The cross-sectional areas are preferably defined in parallel with the main extension plane of the cover element 110.

It may be advantageous for the first compensation element 124 to have a first further depression 170 on a side facing the cover element 110, the cross-sectional area of which is approximately 40% or less, in particular approximately 30% or less, than a cross-sectional area of the first compensation section 134 overall.

Additionally or alternatively, the second compensation section 144 of the second compensation element 126 preferably has a second further recessed region 176. In the region of the second further recessed region 176, an average thickness of the second compensation section 144 is preferably at least approximately 10% less, in particular at least approximately 20% less, and/or at most approximately 80% less, in particular approximately 70% less, than an average thickness of the second compensation section 144 in the surrounding regions.

A cross-sectional area of the second further recessed region 176 is preferably approximately 20% or more and/or approximately 80% or less than a cross-sectional area of the second compensation section 144 overall.

It can be advantageous if the second compensation element 126 has a second further depression 172 on a side facing the cover element 110, the cross-sectional area of which depression is approximately 40% or less, in particular approximately 30% or less, than a cross-sectional area of the second compensation section 144 overall.

It can be advantageous if first degassing openings 140 are arranged offset from one another on a side facing the cover element 110 and on a side of the first compensation element 124 facing away from the cover element 110, along a direction extending in parallel with the main extension plane of the cover element 110.

Preferably, second degassing openings 150 are arranged offset from one another on a side facing the cover element 110 and on a side of the second compensation element 126 facing away from the cover element 110, along a direction extending in parallel with the main extension plane of the cover element 110.

Otherwise, the further embodiment of an electrochemical cell 100 shown in part in FIGS. 16 to 18 corresponds substantially in its structure and function to the first embodiment shown in FIGS. 1 to 9, so that reference is made to the description thereof in this respect.

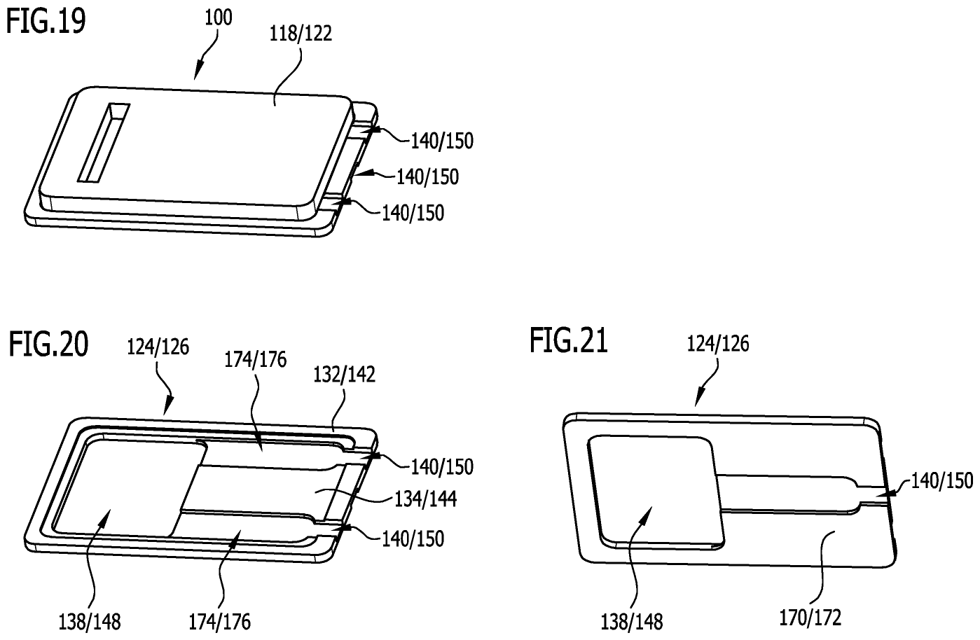

FIGS. 19 to 21 show a cell terminal 118, 122 and a compensation element 124, 126 of a further embodiment of a further embodiment of an electrochemical cell 100 that is not shown in its entirety in the drawings.

The further embodiment of an electrochemical cell 100 shown in part in FIGS. 19 to 21 differs in its structure and function from the embodiment shown in FIGS. 16 to 18 essentially in that the compensation element 124, 126 has two further recessed regions 174, 176.

Preferably, the two first further recessed regions 174 of the first compensation element 124 are arranged in such a way that a first further recessed region 174 and the first further depression 170 are arranged alternately, on a side facing the cover element 110, along a direction extending in parallel with the main extension plane of the cover element 110.

For example, the first further depression 170 is arranged centrally and/or the two first recessed regions 174 are arranged towards sides of the first compensation element 124.

Preferably, the two second further recessed regions 176 of the second compensation element 126 are arranged in such a way that a second further recessed region 176 and the second further depression 172 are arranged alternately, on a side facing the cover element 110, along a direction extending in parallel with the main extension plane of the cover element 110.

For example, the second further depression 172 is arranged centrally and/or the two second further recessed regions 176 are arranged towards edges of the second compensation element 126.

Otherwise, the further embodiment of an electrochemical cell 100 shown in part in FIGS. 19 to 21 corresponds substantially in its structure and function to the embodiment shown in FIGS. 16 to 18, so that reference is made to the description thereof in this respect.

In addition or as an alternative to previously described method or method sections, the first compensation element 124 and/or the second compensation element 126 of the previously described embodiments of an electrochemical cell 100 can also be produced according to embodiments of the method shown in FIGS. 22 to 26.

According to the embodiment of a method for producing an electrochemical cell 100 shown in part in FIG. 22, in order to produce the first compensation element 124 a first polymer material is applied to, for example printed on, in a flowable state, a side of the cover element 110 facing away from the interior space 108 in the mounted state. In this case, the first polymer material is applied, for example printed, around a first opening 125b of the cover element 110.

In addition or alternatively, in order to produce the second compensation element 126, a second polymer material is preferably applied to, for example printed on, in a flowable state, the side of the cover element 110 facing away from the interior space 108. In this case, the second polymer material is applied, for example printed, around a second opening 125b of the cover element 110.

For example, the first edge region 132 and/or the second edge region 142 can be formed by a sealing bead.

Suitable printing processes are a screen-printing method, for example using a screen-printing device, and/or a dispensing process, for example using a dispenser device.

It may be advantageous for the first polymer material and/or the second polymer material to be applied such that the respective polymer material on the cover element 110 is preferably at least approximately the same height over the entire extension of the cover element 110. The height is preferably defined perpendicularly to the main extension plane of the cover element 110.

Before or after curing of the first polymer material and/or the second polymer material, the first compensation section 134 is preferably embossed into the first compensation element 124 and/or the second compensation section 144 is embossed into the second compensation element 126.

Preferably, a polymer material which contains one or more electrically conductive fillers is used as the first polymer material.

The further embodiment of a method for producing an electrochemical cell shown in part in FIG. 23 differs from the embodiment shown in FIG. 23 essentially in that instead of an embossing of the first compensation section 134 and/or of the second compensation section 144, the first edge region 132 and/or the second edge region 142 are increased in height in comparison to the respective compensation section 134, 144. The increase in height can be effected before or after the curing of the first polymer material and/or the second polymer material.

Otherwise, the further embodiment of a method for producing an electrochemical cell 100, shown in part in FIG. 23, substantially corresponds to the embodiment shown in part in FIG. 22, so that reference is made to the description thereof in this respect.

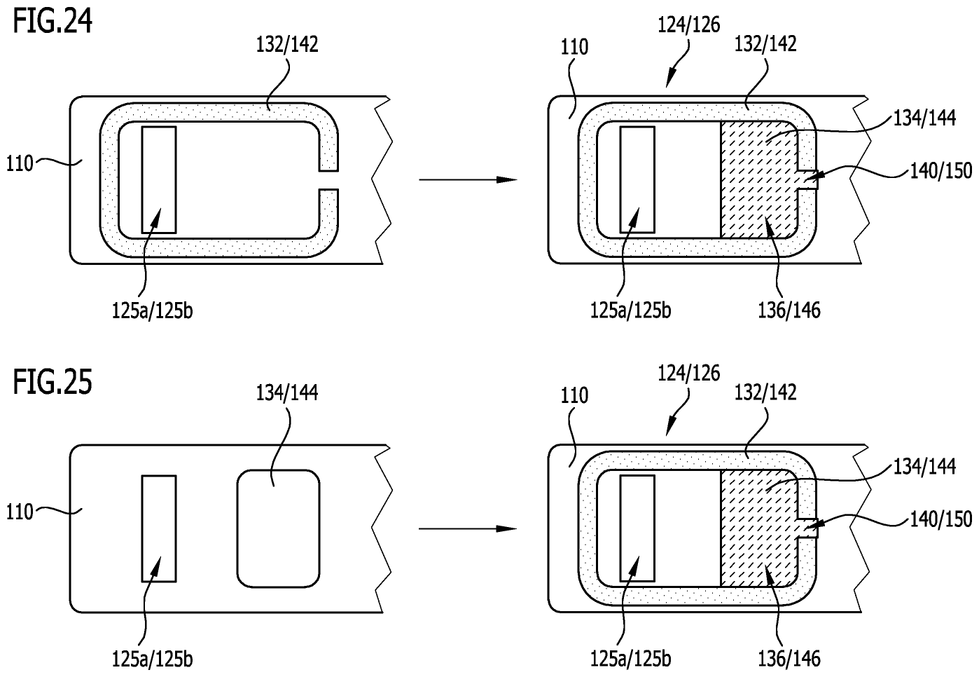

The embodiment of a method for producing an electrochemical cell shown in part in FIG. 24 differs from the embodiment shown in FIG. 22 essentially in that the first edge region 132 and the first compensation section 134, and/or the second edge region 142 and the second compensation section 144, are formed in succession in a plurality of method steps.

For example, the first edge region 132 is firstly applied to the cover element 110, for example printed thereon.

Before or after curing of the first edge region 132, the first compensation section 134 is preferably applied to a region surrounded by the first edge region 132, for example printed thereon.

Additionally or alternatively, the second edge region 134 is firstly applied to the cover element 110, for example printed thereon.

Before or after curing of the second edge region 142, the second compensation section 144 is preferably applied to a region surrounded by the second edge region 142, for example printed thereon.

A dispenser device and/or a screen-printing device is preferably used for printing.

Otherwise, the further embodiment of a method for producing an electrochemical cell 100, shown in part in FIG. 24, substantially corresponds to the embodiment shown in FIG. 22, so that reference is made to the description thereof in this respect.

The embodiment of a method for producing an electrochemical cell shown in part in FIG. 25 differs from the embodiment shown in FIG. 24 essentially in that the first compensation section 134 is applied to the cover element 110 temporally before the first edge region 132, and/or in that the second compensation section 144 is applied to the cover element temporally before the second edge region 142.

Otherwise, the further embodiment of a method for producing an electrochemical cell 100, shown in part in FIG. 25, substantially corresponds to the embodiment shown in FIG. 24, so that reference is made to the description thereof in this regard.

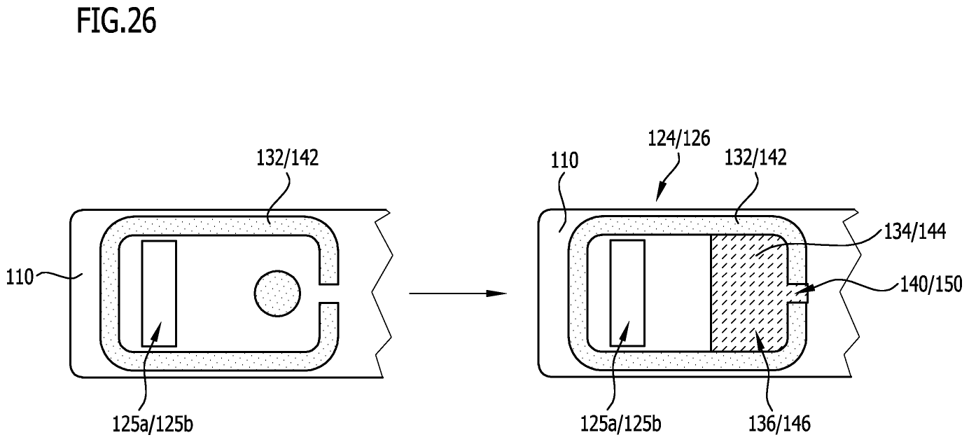

The embodiment of a method for producing an electrochemical cell shown in part in FIG. 26 differs from the embodiment shown in FIG. 22 essentially in that the first edge region 132 and the first compensation section 134 are only connected to one another only by running and/or liquefaction of a material which forms the first compensation section 134.

Additionally or alternatively, the second edge region 142 and the second compensation section 144 are connected to one another only by running and/or liquefaction of a material forming the second compensation section 144.

It may be advantageous for a certain volume, for example a couple of drops, of a material forming the first compensation section 134 to be placed in a region surrounded by the first edge region 132.

A material, for example a first polymer material, which comprises or is formed from a thixotropic material, is preferably used as the material for the first edge region 132.

Preferably, a material is used for the first compensation section 134 which is liquid at least under conditions in which the material of the first edge region 132 is cured, so that the material of the first compensation section 134 flows as far as the first edge region 132.

It can be advantageous if a certain volume, for example a couple of drops, of a material forming the second compensation section 144 is placed in a region surrounded by the second edge region 142.

A material, for example a second polymer material, which comprises or is formed from a thixotropic material, is preferably used as the material for the second edge region 142.

Preferably, a material is used for the second compensation section 144 which is liquid at least under conditions in which the material of the second edge region 142 is cured, so that the material of the second compensation section 144 flows as far as the second edge region 142.

Otherwise, the further embodiment of a method for producing an electrochemical cell 100, shown in part in FIG. 26, substantially corresponds to the embodiment shown in FIG. 22, so that reference is made to the description thereof in this respect.

By using the first compensation element 124 and/or the second compensation element 126, functional effects of volume variations of the first resin material and/or of the second resin material during the production of the electrochemical cell 100 can preferably be compensated. An improved tightness of the first connection region 130 and/or of the second connection region 152 can thus be formed.

1. Electrochemical cell for an electrochemical system, comprising:
an electrochemical element for receiving, storing and/or providing electrical energy;
a housing for accommodating the electrochemical element, wherein the housing surrounds an interior space of the electrochemical cell and comprises a cover element;
a first cell terminal and a second cell terminal for connecting the electrochemical cell to a cell contacting system;
a first connection conductor which connects the electrochemical element to the first cell terminal; and
a second connection conductor which connects the electrochemical element to the second cell terminal,
wherein the first connection conductor is secured to the cover element in a first connection region by means of a first potting element, wherein the first potting element is surrounded and/or accommodated by a first compensation element of the electrochemical cell in the first connection region, and/or wherein the second connection conductor is secured to the cover element in a second connection region by means of a second potting element, wherein the second potting element is surrounded and/or accommodated by a second compensation element of the electrochemical cell in the second connection region.

2. Electrochemical cell according to claim 1, wherein the first compensation element has at least one first depression in which the first potting element is accommodated in part or completely, and/or in that the second compensation element has at least one second depression in which the second potting element is accommodated in part or completely.

3. Electrochemical cell according to claim 1, wherein the first compensation element has a first edge region which surrounds the first potting element, and/or in that the first compensation element has a first compensation section which extends from the first edge region towards the first connecting conductor.

4. Electrochemical cell according to claim 1, wherein the second compensation element has a second edge region which surrounds the second potting element, and/or wherein the second compensation element has a second compensation section which extends from the second edge region towards the second connection conductor.

5. Electrochemical cell according to claim 3, wherein the first edge region of the first compensation element has one or more first degassing openings, the first edge region preferably having a reduced thickness in the region of the one or more first degassing openings, and/or wherein the second edge region of the second compensation element has one or more second degassing openings, preferably the second edge region having a reduced thickness in the region of the one or more second degassing openings.

6. Electrochemical cell according to claim 3, wherein an average thickness of the first edge region, taken perpendicularly to a main extension plane of the cover element, is approximately 20% or more, in particular approximately 50% or more, greater than an average thickness of the first compensation section, taken perpendicularly to the main extension plane of the cover element, and/or wherein an average thickness of the second edge region taken perpendicularly to the main extension plane of the cover element is approximately 20% or more, in particular approximately 50% or more, greater than an average thickness of the second compensation section taken perpendicularly to the main extension plane of the cover element.

7. Electrochemical cell according to claim 3, wherein the first compensation section extends, in a cross-section taken in parallel with a main extension plane of the cover element, over approximately 25% or more, in particular over approximately 30% or more, of a region surrounded by the first edge region, and/or wherein the second compensation section extends, in a cross-section taken in parallel with the main extension plane of the cover element, over approximately 25% or more, in particular over approximately 30% or more, of a region surrounded by the second edge region.

8. Electrochemical cell according to claim 1, wherein the first compensation element comprises or is formed from a first polymer material and/or in that the second compensation element comprises or is formed from a second polymer material.

9. Electrochemical cell according to claim 8, wherein the first polymer material and/or the second polymer material comprises one or more electrically conductive fillers, the one or more electrically conductive fillers preferably being selected from one or more of the following materials:
a₁) one or more carbon-based materials, in particular conductive carbon black, graphite, graphene, carbon nanotubes, carbon fibers and/or carbon nano onions;
a₂) one or more metal powders, in particular of aluminum, copper, titanium, iron and/or silver and/or alloys thereof;
a₃) one or more electrically conductive ceramic materials, in particular nitrides or carbides and/or mixtures thereof; and
a₄) one or more electrically conductive polymer materials, in particular poly(3,4-ethylenedioxythiophene) (PEDOT), poly(styrene sulfonate) (PSS), doped polyacetylene, doped polypyrrole, doped polyaniline, doped poly(p-phenylene), doped polythiophene and/or mixtures thereof.

10. Electrochemical cell according to claim 8, wherein the second polymer material and/or the first polymer material comprises one or more electrically insulating fillers, the one or more electrically insulating fillers preferably being selected from one or more of the following materials: silicon dioxide, metal oxides, in particular transition metal oxides, for example titanium dioxide, chalk, one or more silicates, metal nitrides.

11. Electrochemical cell according to claim 3, wherein the first compensation section is a reworked region, for example a region produced by subsequent embossing, and/or wherein the second compensation section is a post-machined region, for example a region produced by subsequent embossing.

12. Electrochemical cell according to claim 1, wherein the first compensation element comprises or is formed from a coating on the cover element and/or a coating on the first cell terminal of the electrochemical cell, and/or wherein the second compensation element comprises or is formed from a coating on the cover element and/or a coating on the second cell terminal of the electrochemical cell.

13. Electrochemical cell according to claim 1, wherein the first compensation element comprises or is formed from a film, for example a self-adhesive film, and/or wherein the second compensation element comprises or is formed from a film, for example a self-adhesive film.

14. Method for producing an electrochemical cell, for example for producing an electrochemical cell according to claim 1, wherein the method comprises the following:
providing a cover element which comprises a first opening and/or a second opening;
positioning a first connection conductor, which is in particular connected or connectable to a first cell terminal, in the first opening, and/or positioning a second connection conductor, which is in particular connected or connectable to a second cell terminal, in the second opening;
creating a first compensation element in a first connection region between the first opening and the first connection conductor and/or the first cell terminal and filling a first resin material into the first connection region in a casting method, and/or creating a second compensation element in a second connection region between the second opening and the second connection conductor and/or the second cell terminal and filling a second resin material into the second connection region in a casting method;
drying and/or curing the first resin material to form a first potting element, and/or drying and/or curing the second resin material to form a second potting element.

15. Method according to claim 14, wherein the first compensation element is applied to the cover element in a printing process, for example by a screen-printing device or a dispenser device, and wherein an increase in height of a first edge region or an embossing of a first compensation section subsequently takes place, and/or wherein the second compensation element is applied to the cover element in a printing process, for example by a screen-printing device or a dispenser device, and wherein an increase in height of a second edge region or an embossing of a second compensating section subsequently takes place.
